(19) United States
(12) Patent Application Publication
(10) Pub. No.: US 2007/0120338 A1
(43) Pub. Date: May 31, 2007

(54) MATERIAL CARRYING AND LIFTING APPARATUS HAVING A PIVOTING TABLETOP

(76) Inventor: William W. Morgan, Decatur, TX (US)

Correspondence Address: CARSTENS & CAHOON, LLP, P O BOX 802334, DALLAS, TX, 75380, US

(21) Appl. No.: 11/564,654

(22) Filed: Nov. 29, 2006

Related U.S. Application Data
(60) Provisional application No. 60/740,445, filed on Nov. 29, 2005.

(51) Int. Cl. B62B 3/02

(52) U.S. Cl. 280/79.11; 280/35

(57) ABSTRACT

A mobile lifting table having a pivoting tabletop is claimed. A support frame is attached to the base of a cart having a plurality of wheels. A support arm attached to the frame on one end is pivotally attached to a tabletop. The tabletop is in turn pivotally attached to a control arm which raises and lowers the tabletop from an inclined position for loading and carrying materials, to a horizontal position for maneuvering and unloading said material. The control arm is also attached to an operator controlled electric hoist via a pulley system and cable, which translates a force generated by said hoist to said control arm, thus raising and lowering said control arm and causing the tabletop to raise or lower as the operator so desires. The tabletop includes a means for rolling the material across the table such that said material is easily maneuverable by the operator.

### RELATED APPLICATIONS

This application claims the benefit of U.S. Provisional Application No. 60/740,445, filed on Nov. 29, 2005 and is incorporated by reference herein.

### FIELD OF THE INVENTION

The present invention relates generally to an apparatus for carrying and lifting materials, and in particular, to a mobile lifting table having a mechanized pivoting tabletop which is configured to carry said material in an inclined position, and to rotate to a raised horizontal position for maneuvering and unloading said material.

### DESCRIPTION OF THE RELATED ART

Artisans in the home construction and improvement business must often transport and lift heavy materials during the course of their work. Due to limited space within the home and the need to prevent damage to existing structures and furnishings within the home, a plurality of persons, instead of machinery, have traditionally provided the required muscle to lift and maneuver materials used in such work. For example, during the installation of a stone countertop into a home's kitchen, it is often necessary to utilize many persons in the carrying and lifting of the countertop which could weigh in excess of five hundred pounds. Persons involved with such carrying and lifting often suffer from various injuries resulting from the strain of their work.

Various apparatus are revealed in the prior art which are adapted for lifting heavy materials. These apparatus include a horizontal table on which material may be loaded while the tabletop is at an inclined position. A user controlled lifting means raises the tabletop and material to a desired height where it may then be unloaded or otherwise manipulated. Although the prior art horizontally lifting tables may be effectively used in work areas designed for their use, such tables, even if made mobile, are often too large to enter into and navigate the tight confines of a home. Another drawback of such prior art tables is that they are often quite heavy themselves, thus making it impractical for an artisan to easily transport them to different jobsites.

Therefore, a need exists for a mobile lifting table which is capable of transporting and lifting heavy materials while at the same time being configured to minimize the size of the table so as to be able to effectively navigate the tight confines of a home or other similar work area.

### SUMMARY OF THE INVENTION

Accordingly, there is provided herein, a mobile lifting table that, in its preferred embodiments, is capable of carrying heavy materials through areas with little room to maneuver, and of lifting said materials to a height where they may be easily unloaded.

In one aspect of the invention, a cart having a plurality of wheels is configured to serve as a platform upon which a tabletop supporting frame is attached. At least one support arm having two ends is attached to the upper portion of the support frame on one end, and pivotally attached to a tabletop on the other end. The support frame is dimensioned with respect to the cart such that said frame rests over only a rearward portion of the cart, thus allowing the tabletop to pivot, via a hinge, on the support arm to a inclined position for carrying materials. By carrying materials on the tabletop in the inclined position, as opposed to the horizontal position, the apparatus may be easily maneuvered through tightly confined work areas. The increased maneuverability exhibited by the present invention demonstrates one advantage over lifting tables revealed in the prior art.

In another aspect of the invention, at least one control aim is attached to the rear portion of the table, said control arm delivering the force necessary to pivot the table between horizontal and inclined positions. An electric hoist connected to a pulley system, which is in turn connected to the control arm, generates the force necessary to raise and lower said control arm of the presently preferred embodiment. The electric hoist is mounted on a support plate which is attached to the base of the cart. An electric cord which is wound around a retractable spool that is mounted to the support plate, supplies the electric hoist with the electricity to power said hoist. A control device connected to the hoist allows an operator to control raising and lowering of the table. A removable covering having openings for the passage of the electric cord, the control device, and the control arm, is attached to the frame resting on the base of the cart.

In yet another aspect of the invention, the table is comprised of a plurality of horizontal and vertical bars, such that when the table is lowered, the horizontal bars are parallel with the ground and the vertical bars are nearly perpendicular with the ground. Rolling sleeves are fitted around a substantial number of the horizontal bars such that when the table is in the raised position, material may be easily rolled over the sleeves and unloaded with minimal effort by the operator. The edge of the table closest to the ground when in the lowered position includes a means for supporting the material on said table, thus preventing the material from rolling off the tabletop before the operator intends to do so.

### BRIEF DESCRIPTION OF THE DRAWINGS

A more complete understanding of the mobile lifting table of the present invention may be had by reference to the following detailed description when taken in conjunction with the accompanying drawings, wherein:

FIG. 1 is a side view (surface of plated cover not visible) of the mobile lifting table according to a preferred embodiment of the present invention;

FIG. 2 is a side view of the mobile lifting table shown in FIG. 1 showing the plated cover;

FIG. 3 is a rear view of the mobile lifting table shown in FIG. 1 with the cover removed;

FIG. 4 is a rear view of the mobile lifting table shown in FIG. 1 with the cover installed;

FIG. 5 is a top view of the mobile lifting table shown in FIG. 1; and

FIG. 6 is a top view of the tabletop according to a preferred embodiment of the present invention.

Preferred embodiments of the mobile lifting table according to the present invention will now be described in detail with reference to the accompanying drawings.

### DETAILED DESCRIPTION OF THE PREFERRED EMBODIMENTS

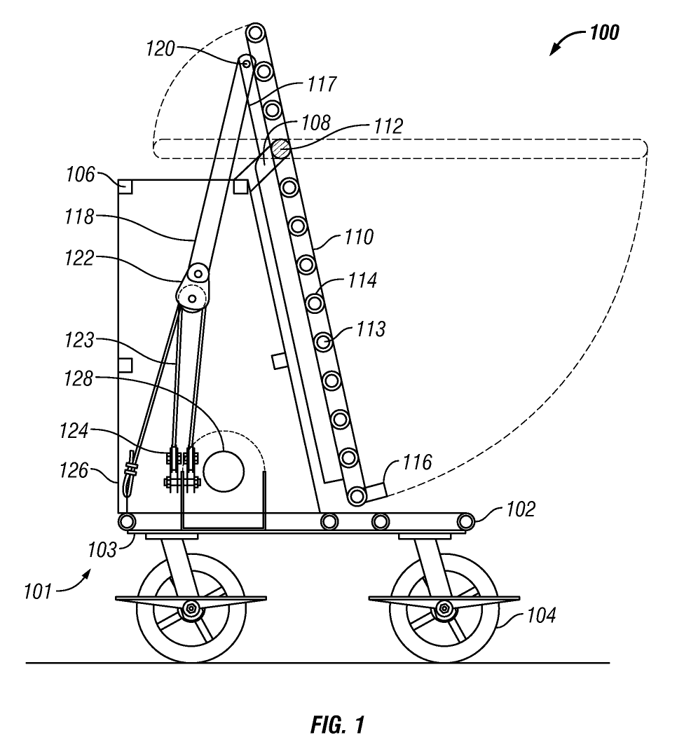

Referring to FIG. 1, a side view of the mobile lifting table 100 according to a preferred embodiment of the present invention; a cart 101 comprising a platform 102 having a plurality of wheels 104 attached thereto, provides a mobile base for the table. The wheels 104 of the presently preferred embodiment are configured to swivel, thus allowing the table 100 to move in any direction as the operator positions the material for unloading. However, as those skilled in the art will appreciate, one or more wheels 104 may include brakes for securing the movement of the table, and directional locking mechanisms to prevent the swiveling of the locked wheel 104 when desired, thus allowing the cart 101 to be more easily controlled during movement over greater distances. It should be noted that although not contained within the presently preferred embodiment, a mechanized means for propelling the mobile lifting table 100 may be included within alternate embodiment of the invention. The platform of the presently preferred embodiment is constructed of steel tubing under which a steel base plate 103 is securely attached.

A support frame 106 is also attached to the platform 102 and is constructed of square steel tubing which has been positioned both horizontally and vertically (not shown). It should be noted and appreciated by those skilled in the art that materials other than those specifically described herein may be utilized to construct the elements of the table 100. For example, those skilled in the art may choose to construct the support frame 106 with a material other than steel tubing. In fact, the materials used to construct the table 100 should be chosen with regard to their properties including, but not limited to properties such as strength and density.

A support arm 108 having two ends is attached to the support frame 106 on one end and attached to a pivoting tabletop 110 on the other end. Although the support arm 108 of the presently preferred embodiment of the invention is integrally attached to the support frame 106, it should be noted that alternate embodiments of the invention may include a support arm 108 which may be adjusted with respect to said support frame 106 such that the height of the tabletop 110 in the horizontal position may be raised or lowered to suit the needs of the operator. Such alternate embodiments may include a support arm 108 which is capable of being secured at a plurality of positions with respect to the support frame 106.

The tabletop 110 is attached to the support arm 108 via a hinge 112, allowing said tabletop 110 to pivot between a lower inclined position, and a raised horizontal position. The support frame is positioned over only a portion of the cart 101, thus allowing the inclined tabletop 110 to rest over the cart 101 while the material is carried. Because the tabletop 110 does not extend further than the platform 102 when it is in the inclined position, the mobile lifting table 100 effectively minimizes the space it needs in which to maneuver. This provides an advantage over other lifting tables revealed in the prior art in that it may more easily pass through narrow passageways and navigate around other obstacles common in work areas such as homes. The tabletop 110 of the presently preferred embodiment is constructed of steel tubing which has been positioned both horizontally 113 and vertically (not shown). A roller sleeve 114 surrounds each horizontal crossbar 113, thus providing a means for easily moving material along the tabletop 110 when unloading or otherwise positioning said material (not shown). The roller sleeves 114 of the presently preferred embodiment are constructed of “PVC” material which is sized to allow the material to roll across the tabletop 110 with only moderate resistance. Those skilled in the art will appreciate that a roller sleeve 114 which is more tightly fit around a horizontal crossbar 113 will provide more rotational resistance than a roller sleeve 114 which less tightly fit around said crossbar 113. Therefore, roller sleeves 114 of alternate embodiments may be constructed of other materials and sized to provide increased or decreased rotational resistance to the material to be rolled thereon. Furthermore, any means for decreasing frictional resistance between the tabletop 100 and the materials placed thereon is contemplated and may be implemented in alternate embodiments.

The tabletop 110 includes a means for supporting the material on said tabletop 110 while not in the horizontal position, as well as preventing said material from rolling off the tabletop prior to unloading it. The tabletop of the presently preferred embodiment includes two fixed support tubes 116 which provide the means for supporting the materials when said tabletop is in the inclined position. However, alternate embodiments of the invention may include support tubes that may be lowered or removed.

A support beam 117 is integrally attached to the underside of the tabletop 110 and further pivotally attached to a control arm 118 via a hinge 120. The end of the control arm 118 not attached to the support beam 117 is attached to two pulleys 122. The pulleys 122 attached to the control arm are connected to a steel cable 123 which is in turn connected to a system of pulleys 124. One end of the cable is anchored 126 to the platform and the other end is connected to an electric hoist 128 that is configured to extend or retract said cable 123, thus lowering or raising said control arm 118 respectively. The electric hoist 128 is controllable by the operator and thus provides the means by which the tabletop 110 and any material supported thereon, is raised and lowered. The electric hoist 128 of the presently preferred embodiment has a power rating of 1.5 horsepower and is capable of retracting a single line at a rate of 33 feet per minute. The electric hoist 128 is securely mounted to the top of the base of the platform 102. Although, the electric hoist 128, in combination with the pulley system 124, is capable of hoisting a line with over 10,000 pounds of tension, the presently preferred embodiment is limited by the limitations of the steel cable 123 (2,200 lb. test rating) and the pulleys 122, 124 (1000 lb. rating). Nevertheless, the mobile lifting table 100 of the presently preferred embodiment is capable of lifting materials in excess of 800 pounds. It should be noted that any means for generating and applying a rotational force to said tabletop is contemplated and may be implemented in alternate embodiments of the mobile lifting table 100. For example, it is contemplated that pneumatic and hydraulic means for rotating the tabletop 110 may be implemented with respect to alternate embodiment of the invention.

Although the mobile lifting table of the presently preferred embodiment utilizes only one control arm and one pulley system, alternate embodiments of the invention may be easily configured to include a plurality of control arms with connected pulley systems such that greater loads may be lifted by the hoist. Furthermore, alternate embodiments may be configured to include electric hoists 128 having power ratings different from that which is described herein in order to lift materials of varying weight. Similarly, various pulley configurations comprising various types of pulleys may be implemented with respect to the invention. However, the pulleys used in the presently preferred embodiment are drop-side snatch blocks having 2 inch diameters. It should be noted that unless otherwise noted, integral attachments of the elements of the table 100 are made by welding said elements together.

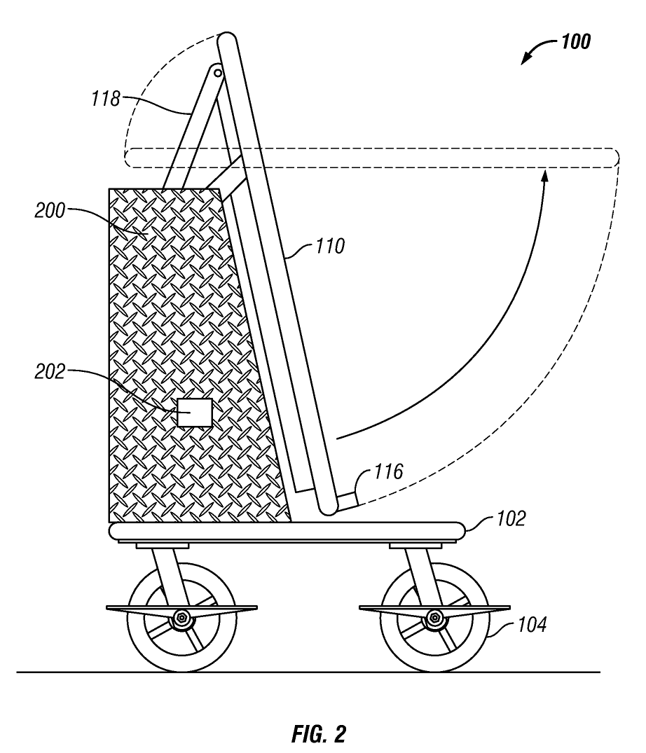

Referring to FIG. 2, a side view of the mobile lifting table 100 having a cover 200 over those elements resting within the support frame 106. The cover is removably attached to the support frame, thus providing access to the electric hoist 128, the pulley system 124, and the control arm 118. Although not seen in FIG. 2, covers 200 surround the support frame on at least four sides of the presently preferred embodiment. An opening 202 is formed on the side of one of the covers to allow the passage of a retractable electric cord (not shown) which supplies the electric hoist 128 with electricity.

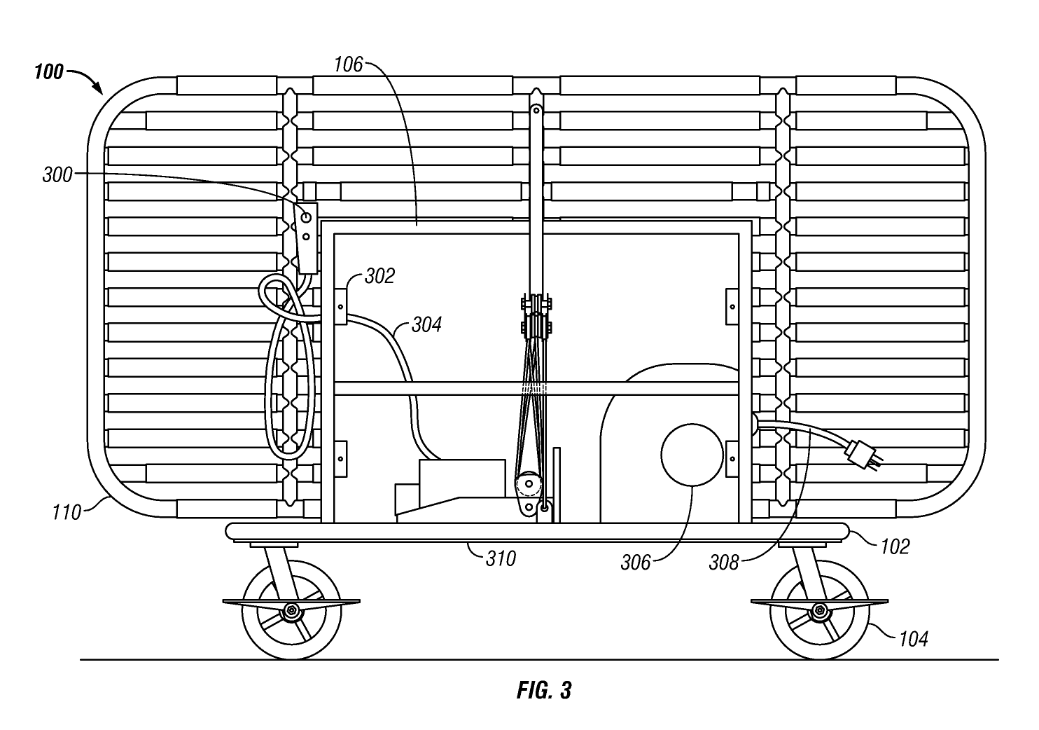

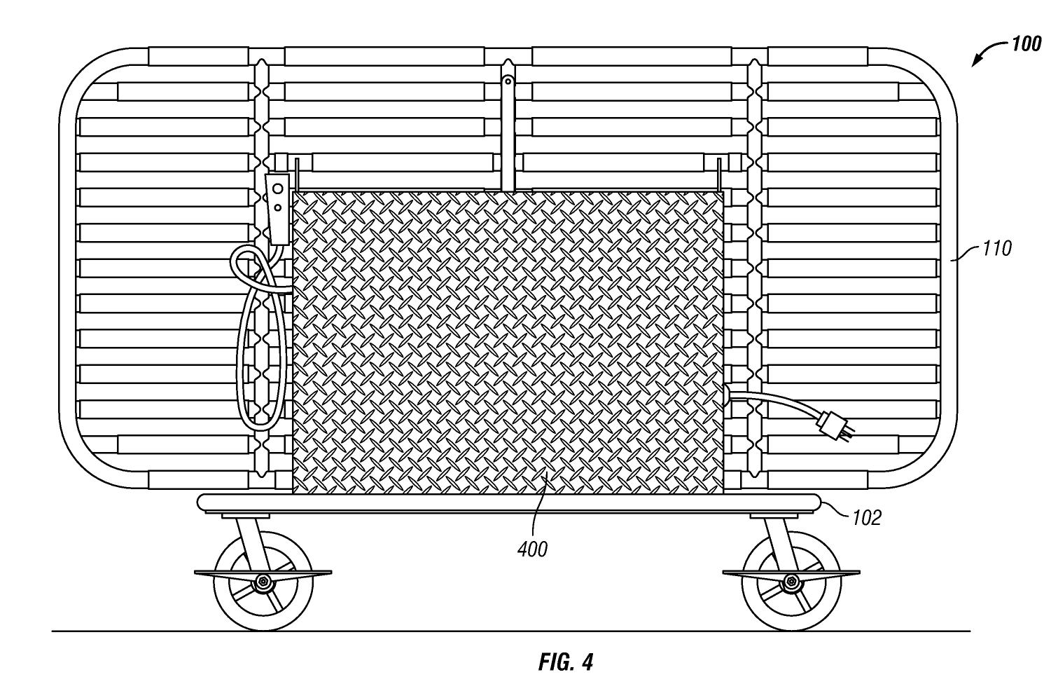

Referring to FIG. 3 and FIG. 4, rear views of the mobile lifting table without and with a cover respectively. A control device 300 is connected to the electric hoist 128, providing the operator of the table 100 with the ability to control the raising and lowering of the tabletop 110. Such control devices 300 are well known in the art and may include one or more switches for controlling the hoist 128. A second opening (not shown) is formed in one of the covers, allowing the conductor 304 which electrically connects the control device 300 and the electric hoist 128, to pass through said cover. Brackets 302 formed on the support frame 106 are utilized in mounting the rear cover as shown in FIG. 2. A retractable spool 306 houses an electric cord 308 which provides electricity to the electric hoist. The electric cord 308 may be conveniently stored on the spool 306 when not in use.

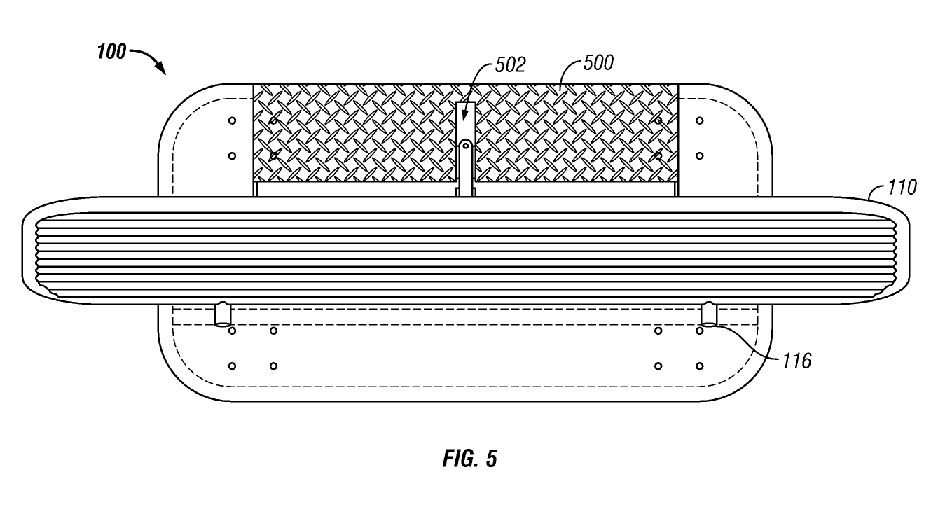

Referring to FIG. 5, a top view of the mobile lifting table is shown having a top cover 500 attached to the support frame 106. An opening 502 is formed in the cover and sized to allow the control arm to freely move during the raising and lowering of the tabletop 110.

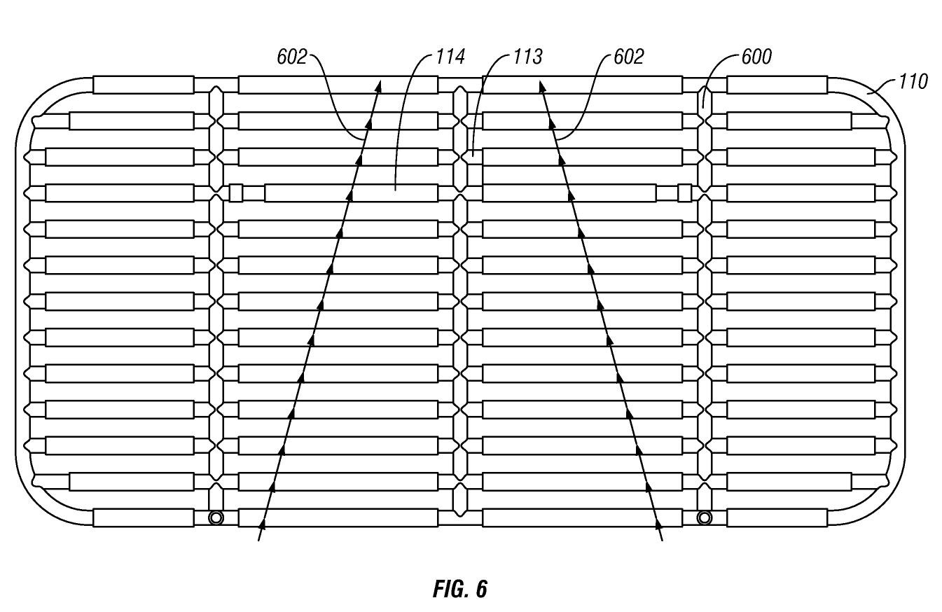

Referring to FIG. 6, a top view of the tabletop 110 according to a preferred embodiment of the invention, said tabletop 110 is comprised of both vertical 600 and horizontal 113 crossbars. Both the horizontal 113 and vertical 600 crossbars are evenly spaced to provide a structure upon which the operator may load material to be carried and lifted. The roller sleeves surround each horizontal 113 crossbar, allowing material to roll across the tabletop 110. Although the arrows 602 indicate the preferred direction that materials are to be unloaded, it is contemplated that an operator may roll and unload said materials in the opposite direction of the arrows 602 as well.

I claim:

1. A mobile lifting table comprising:
(a) a cart having a base and one or more wheels;
(b) a support frame attached to said base, said support frame including at least one support arm attached to an upper portion of said support frame;
(c) a tabletop pivotally attached to said support arm;
(d) a means for generating and applying a rotational force to said tabletop;
wherein said means for generating and applying a rotational force to said tabletop allows an operator to lower said tabletop to an inclined position for loading and carrying material and to raise said tabletop to a horizontal position for unloading or maneuvering said material.

2. The mobile lifting table according to claim 1 wherein said means for applying and generating a rotational force to said tabletop is provided by a control arm which is pivotally attached to said tabletop on one end and connected to a pulley system and electric hoist on the other end, wherein said electric hoist extends and retracts a cable attached to said pulley system and said platform, whereby said tabletop may be thus lowered and raised respectively by said operator.

3. The mobile lifting table of claim 1 wherein said tabletop is comprised of a plurality of both horizontal and vertical crossbars, wherein rolling means are attached to one or more crossbars.

4. The mobile lifting table of claim 2 wherein said rolling means comprises tubing sized to surround the horizontal crossbar to which it is attached wherein said tubing is adapted to rotate with respect to said attached crossbar when material is pushed across said tabletop.

5. The mobile lifting table of claim 1 wherein one or more wheels may include brakes.

6. The mobile lifting table of claim 1 wherein one or more wheels may include a directional locking mechanism.

7. The mobile lifting table of claim 1, further comprising a means for propelling said table.

8. The mobile lifting table of claim 1 wherein said support frame rests upon only a portion of said cart, whereby said tabletop does not extend laterally beyond said cart when in an inclined position.

9. The mobile lifting table according to claim 1 wherein said means for applying and generating a rotational force to said tabletop is provided by a hydraulic means.

10. The mobile lifting table according to claim 1 wherein said means for applying and generating a rotational force to said tabletop is provided by a pneumatic means.
